(19) United States
(12) Patent Application Publication
(10) Pub. No.: US 2008/0267216 A1
(43) Pub. Date: Oct. 30, 2008

(54) Method and System for Transmitting a Multimedia Data Stream

(75) Inventor: Denis Vergnaud, Le Havre (FR)

Correspondence Address: YOUNG & THOMPSON, 209 Madison Street, Suite 500, ALEXANDRIA, VA, 22314, US

(73) Assignee: MEDIATVCOM, ISSY LES MOLINEAUX (FR)

(21) Appl. No.: 12/097,541

(22) PCT Filed: Dec. 15, 2006
(86) PCT No.: PCT/FR06/02755

§ 371 Date: Jun. 16, 2008

(30) Foreign Application Priority Data
Dec. 16, 2005 (FR) 05/12786

(51) Int. Cl. H04L 29/08

(52) U.S. Cl. 370/474

(57) ABSTRACT

Method of transmitting a multimedia data stream (F) from at least one sender to at least one receiver through a link including a communication network (14) of Internet type using the IP protocol, the method comprising the following steps: packetization, at the sending end, of at least part of the data of the multimedia data stream (F) in accordance with a predefined format, transmission of the packets (22) thus formed from the sender to the receiver, at least a part of the link between the sender and the receiver consisting of a plurality of predefined distinct physical paths (21). The invention makes it possible to exceed the throughput limits imposed by a single transmission line. The user can therefore expect the throughput that he desires by multiplying up the number of physical paths at least between the sender and the network or between the network and the receiver.

The present invention relates to a method and a system for transmitting a multimedia data stream from one or more transmitters to one or more receivers, through a transmission network.

This method relates in particular to a method and a system for transporting video data on a communication network using the IP protocol (Internet Protocol).

The field of the invention is the field of telecommunications and in particular telecommunications applied to the field of multimedia.

The invention applies more particularly to the transport of multimedia data on a communication network of the Internet type using the IP protocol. The multimedia data concerned are in particular sound and/or animated images.

In fact, high data rate links on IP are becoming common in Europe, Asia, North America and Africa. The latter are made possible by economical access methods such as ADSL (Asymmetric Digital Subscriber Line) or satellite IP for example. There is at present, depending of the markets, a more or less rapid increase in access data rates. At the same time, the QoS (Quality of Service) in the IP networks is improving, making it possible to carry synchronous streams such as voice or video. This is particularly true in VPN (Virtual Private Networks) networks based on the IP and MPLS (Multiprotocol label switching) technologies. Moreover, the QoS mechanisms provided in IPv4 (Internet Protocol version 4) are generalized and extended in IPv6 (Internet Protocol version 6).

RTP means “Real-time Transport Protocol”, a transport level protocol (level 4 in the OSI model). Even though it is a transport level protocol, this protocol adds a certain number of application functions, such as the transport of the reference clock for example. It was designed for transporting real-time streams, typically of audio and video, on IP networks.

RTP Stream: this is a concept equivalent to the RTP session defined in [PTP]. It is an RTP stream defined by a pair of transport source/destination addresses, each defined by an IP address/UDP port pair.

Transport Address: Origin or destination of a UDP or RTP data stream in our environment. Defined by the IP address/(UDP, User Datagram Protocol or TCP, Transmission Control Protocol) port pair.

Transport Stream or TS: this is the format commonly used in the field of digital television for the transport of multiplexed audiovisual data streams. The TS format is defined in [ISO 13818-1].

Encoder: Equipment for digitizing (if necessary), compression and encoding of audio and video data.

Decoder: Equipment for decoding, decompressing and formatting (analogue for example) compressed audio and video streams.

RTT: Round Trip Time: the time taken for a packet to pass through the network in order to reach its destination.

Moreover, the word “stream” designates, by extension, any stream of data or stream of packets if these data are packetted. The term “stream fragment” designates a portion of the data or packets of an original stream, optionally encapsulated in another data or packet format.

At present, editors of television programmes, broadcasters, producers and post-producers have, in the majority, remained hostile to IP technologies for the transport of their contributing audiovisual streams (studio to studio typically) and to broadcast contribution (final control to transmitter for example), preferring to stay with satellite technologies or with old-generation telecom technologies or very close to the physical signal (direct modulation on dark fibre, SDH or Synchronous Digital Hierarchy, PDH or Plesiochronous Digital Hierarchy for example). Their reticence is partly justified by the inability of IP to manage problems of jitter, low rate of loss of packets and redundancy in real time.

However, the increase in telecommunication data rates on IP, the reduction in the costs of IP installations generated by the generalisation of IP equipment, the provision of genuine quality of service by the operators of services on IP and the integration in end-equipment of jitter problematics processing is allowing those involved in this field to turn towards IP technologies.

Several problems persist however. On the one hand, the data rate of the access lines, in particular xDSL (xDSL: any type of DSL) in the “upload” (user to network) direction is generally very limited. The new VDSL technologies will allow in their most common deployment a data rate of 2 Mb/s for “upload” only. On the other hand, the IP networks, xDSL in particular, always have packet loss rates greater than that which is commonly observed on the Telecom networks, particularly if referring to the Internet, and their packet loss rates are still too high for the professional transport of video.

One objective of the invention is thus to propose a method and a system making it possible to increase the data rates of transmissions of multimedia signals over IP.

Another objective of the invention is to propose a method making it possible to provide a better guarantee of routing and greater continuity of functioning than the present systems offer.

The invention proposes solving the abovementioned problems and achieving the objectives noted above by a method of transmitting a multimedia data stream from at least one transmitter to at least one receiver through at least one link comprising at least one communication network of the IP type, the said method comprising the following steps:
packeting, on transmission, of at least a portion of the data of the multimedia data stream according to at least one predefined format; and
transmission of the packets thus formed from the transmitter to the receiver, at least one part of said link between the transmitter and the receiver being constituted by a plurality of predefined separate physical paths.

Advantageously, using the method according to the invention, the link between the transmitter and the communication network, or between the communication network and the receiver comprises a plurality of physical paths. These paths can convey packets in parallel. The connection of each physical path with the network can be carried out, for example, using means of the modem type.

The invention thus makes it possible to exceed the data rate limits imposed by a single connection line. The user can therefore achieve the data rate that he desires by multiplying the number of physical paths between the transmitter and the network or between the network and the receiver.

In a preferred embodiment of the invention, the method can be used for carrying out a transmission of a multimedia data stream in real time, with integrated jitter processing and very low latency times.

Moreover, the fact that the connection between the receiver and the network or between the transmitter and the network is constituted by a plurality of physical paths allows, in particular, the use of at least a portion of the available data rate of the lines as backup for each other, which makes it possible to increase the guarantee of routing and the continuity of functioning of the system arranged to implement the method according to the invention.

The method according to the invention can moreover comprise a splitting (I) of the multimedia data stream (F) constituting a partition of the packets of said stream in at least one set, called a fragment, containing at least one packet.

Advantageously, the splitting of the stream is carried out at a data rate adjusted according to at least one parameter, called weight, determined as a function of at least one item of data chosen from the following list, initialisation parameter, transmission quality indicator, data rate relative to another operation.

The method according to the invention can, in particular, comprise a distribution of the data stream over a plurality of physical transmission paths, as a function of information relating to at least one transmission path. The objective of this distribution is to divide the multimedia data stream between a plurality of physical paths according to distribution constraints.

In particular, the distribution can take account of the total data rate to be routed and the transmission data rates on each transmission line, in order to then divide the multimedia data stream to be transmitted between the different transmission lines. Other constraints, such as minimum or maximum data rates fixed by a user, can be taken into account during this distribution.

The splitting of the multimedia data stream into a plurality of stream fragments and/or the distribution of data packets over a plurality of paths can for example be carried out by a sequencer using a sequence of the weighted Round Robin type. This sequencing is well known to those skilled in the art. For more information see sections 2.3.2 and 2.3.2.1 of “Étude des algorithme d'attribution de priorités dans un Internet à Différentiation de Services (Study of priority allocation algorithms in an Internet with Differentiation of Services)”Octavio Napoleon MEDINA CARJAVAL, March 2001, or httg:/iwww.rennes.enst-bretagne.fr/˜medina/these/these-medina.pdf or also http://www.linuxvirtualserver.org/docs/scheduling.html.

The splitting of data packets can be adjusted dynamically, essentially according to at least one effective fixed or variable transmission data rate on at least one path. In fact, the effective transmission data rates can vary in each line. This variation can give rise to an adjustment of the splitting according to new values of data rates obtained after variation.

The splitting of data packets can be adjusted dynamically essentially according to at least one value of transmission jitter on at least one path.

Other values can advantageously complete the list of values allowing the dynamic adjustment of the splitting. It can for example be the packet loss rate or the packet resequencing rate.

In an advantageous version of the invention, the packeting stage can comprise at least one encapsulation of the data in a packet in accordance with the Real Time Protocol (RTP) on at least one path. This encapsulation can be unique to each path. The fact of using this format makes it possible:
to retain, if necessary, a stream of data conforming with RTP and without error. If the packets had been inserted in the network without modification, the incident multimedia data stream would not have conformed with RTP because it would have had discontinuities in the SN (Sequence Number). This stage is carried out if the input data are already inserted in packets according to the RTP format
to measure the quality of each transmission link independently, using mechanisms appropriate to a standard RTP layer,
to transport timestamp information independent of the original multimedia data stream, generated by the transmitter and optionally unique to each path. This makes it possible to ensure a regeneration of the multimedia data stream on reception whilst eliminating the jitter effect induced by the network on each path,
to preserve the original information of the original multimedia data stream in order to retrieve it on reception, and to ensure high-performance reassembly.

In an advantageous version of the invention, the method can comprise a sending of data packets from the transmitter to the receiver through at least one physical transmission path, the sending being carried out according to a variable transmission data rate on said transmission path. In fact, the sending of the packets from the transmitter to a receiver through the transmission network, can be carried out with a shaping of the sending data rate. This shaping of data rate or “traffic shaping” can be carried out on the basis of conventional algorithms, for example “token bucket filter”, well known to those skilled in the art.

Advantageously, the method according to the invention can comprise a transmission of data packets from the transmitter to the receiver, through a plurality of physical paths, each one of the these physical paths being addressed by the transmitter by means of one or more IP (Internet Protocol) addresses. Once the data packets are ready to be sent to the transmission network in order to be transmitted to the receiver, they are sent by the transmitter on a plurality of physical paths which form the link between the transmitter and at least one transmission network. These physical paths which can carry data packets in parallel, are addressed by the transmitter by means of an IP destination address, a UDP port, a network interface and an IP network access gateway address if necessary (according to the network architecture). Thanks to these addresses, the transmitter sends on each physical path the packets which must be carried by these paths in order for them to be injected into at least one transmission network.

In an advantageous version, the method according to the invention can moreover comprise a reception, by the receiver, of data packets on a plurality of physical paths, each of these physical paths emerging on a (IP address, UDP port) pair. In fact, the data packets which are sent by the transmitter on a plurality of physical paths by means of a plurality of network interfaces, to the receiver through the transmission network, are received at the receiver on one or more paths each comprising at least one network interface. Each path ends, in particular, on a (IP address, UDP port) pair. This is what makes it possible to differentiate the different paths on reception.

According to an advantageous feature of the method according to the invention a reception of a new packet is followed by a sequencing of this packet in a queue in accordance with information relating to the new received packet and/or to at least one previously received packet. The information taken into account during such sequencing can for example be the SN (Sequence Number) or the TS (Timestamp) of the RTP packet. The packets can be sequenced in a queue which is specific to each physical reception path or in a queue common to one or more reception paths. During this sequencing there can be correction operations on the data packets received, such as the elimination of doubled packets for example.

Moreover, the latencies on all the paths not necessarily being the same, the queue or queues in which the packets are sequenced can compensate for a possible latency and thus make it possible to put the data streams from the different paths back into phase in order to facilitate the recomposition of the original stream.

The information contained in the data packets (TS (Timestamp)) information can be used on reception in order, for example, to synthesize a local clock which is the image of the clock used on transmission.

The synthesized clock can used to control the output data rate of the receiver and to eliminate jitter.

In an advantageous version, the method according to the invention can comprise a reassembly of a plurality of packets received on a plurality of physical link paths between the transmission network and the receiver, said packets being selected on said plurality of paths as a function of the information that they contain. The selection of a packet, for example in a queue of sequenced packets specific to a path, can be done according to the original order number (SN in the case of RTP) of the data packet. In order to overcome phenomena of latency between the paths, the method according to the invention makes it possible not to take into account the SN of the packet instantaneously. This also makes it possible to overcome certain problems, such as loss of packets problems for example.

Moreover, the invention can advantageously comprise an extraction of multimedia data from at least one received packet. This extraction makes it possible to extract the data of the original multimedia data stream from a packet in which these multimedia data have optionally been able to be encapsulated. The original data can then advantageously be inserted in an output queue, for reconstituting the original multimedia data stream.

At the moment of the insertion of the original data in an output queue, the method according to the invention can comprise a resequencing of these data in the output queue.

The method according to the invention can advantageously comprise an output of the data of the original multimedia data stream to another equipment. At this stage, the data can for example, be extracted from an output queue and be sent to the equipment in question. This operation can, in a particular embodiment, be carried out by a module allowing suppression of jitter and control of output data rate.

Advantageously, the method according to the invention can comprise a matching allowing a formatting of the data of the multimedia data stream to be transmitted according to at least one predefined format. This matching can be carried out at the input of the transmitter in order to format the original multimedia data stream to be transmitted according to a predefined format and/or at the output of the receiver in order to format the multimedia data stream at the output of the receiver in order to send it to equipment requiring a particular formatting on reception.

In particular, the formatting of the data can be carried out at a data rate adjusted as a function of at least one parameter chosen from the following list: initialisation parameter, a transmission quality indicator, any data rate.

For example, it is possible to control the encoding rate of an encoder (MPEG2 for example) according to the abovementioned parameters. This encoder can be integrated or not integrated in the transmitter.

In one advantageous feature, the method according to the invention can comprise, on reception, a correction of at least one error in the transmission of received multimedia data packets thanks to redundant data. This correction can, in particular, be carried out by a technique comparable with FEC (Forward Error Correction). The errors which can be corrected are, for example, packet loss or a reception of data degraded during the transmission.

In order to do this, the transmission of data from the transmitter to the receiver can advantageously comprise a sending, from the transmitter to the receiver, of redundant packets of the multimedia stream to be transmitted. These redundant data can be encapsulated in packets according to a predefined format. These redundant data packets can be any combination of the data packets of the original multimedia data stream before the splitting stage or streams obtained after the stage of splitting this original stream and can be sent to the receiver, on a single physical path or in the same way as the data packets of the multimedia data stream, i.e. on a plurality of physical paths, optionally separate from those used by the fragments of multimedia data stream.

According to an advantageous feature, the method according to the invention comprises a feedback, from the receiver to the transmitter, making it possible to regulate the transmission of the multimedia data packets, said feedback being carried out by a sending, from the receiver to the transmitter, of at least one indicator relating to the transmission of the packets on at least one physical path.

In an advantageous version of the invention, the feedback can be carried out on at least one physical path.

In this case, the method according to the invention can comprise a measurement of at least one transmission quality indicator on at least one physical link path as a function of information relative either to the transmission, or to the multimedia data transmitted on said path, or to both.

The measured indicators can comprise the following indicators:
the number of packets received and data rate,
the number of packets lost,
the number of unsequenced packets received,
the jitter, and
the amount of desynchronisation of the stream,

These indicators can be calculated by conventional methods. These indicators can advantageously be calculated as a function of information concerning the transmission of data stream on each physical path.

The calculated indicators can be transmitted by the receiver to the transmitter in accordance with the TCP/IP protocol, through an IP communication network of the Internet type, identical or not with the network used for the transmission of the multimedia data stream.

Advantageously, the feedback can give rise to an adjustment of a data transmission rate on at least one path as a function of at least one indicator relating to the transmission. It can also, for example, give rise to a variation of an overall encoding rate on at least one internal or external encoder if that is possible.

Moreover, the indicators can be received by a receiving module at the transmitter and transmitted to one or more control modules, such as a module controlling splitting, a module controlling encoding data rate, a module controlling signal transmission on at least one path, etc. in order to be used in the readjustment of the data rate of the operations carried out by these modules.

According to another aspect of the invention, a system is proposed for transmitting a multimedia data stream from at least one transmitter to at least one receiver through at least one link comprising at least one communication network using the IP protocol, comprising:
means of putting into packets, on transmission, at least a portion of the data of the data stream according to a predefined format;
means of transmission of the packets thus formed from the transmitter to the receiver through said communication network; and
means of linking said transmitter to said receiver, at least a portion of said link being constituted by a plurality of predefined separate physical paths.
   The architecture used can advantageously be a microprocessor and bus architecture, both for the transmitter and for the receiver. This architecture allows great modularity in terms of input and output and makes it possible to accept any type of input and output interfaces adapted to that bus. Typically, a bus of PCI 32 or PCI 64 (which also includes Compact PCI and PMC) technology can be used. For more of information on these technologies see http://www.pcisig.com/specifications/order form or https://www.picmg.org/specorderformsec-nonmember.stm or also http://shop.ieee.org/leeestore/Product.aspx?product no=SH94922.

According to an advantageous version, the system according to the invention can comprise means of feedback from the receiver to the transmitter making it possible to regulate the transmission of the multimedia data packets, said feedback being carried out by the sending from said receiver to said transmitter of at least one indicator to the transmission.

Advantageously, the system can comprise means of correction of at least one error of transmission of received multimedia data packets due to redundant data. These means can furthermore comprise means of constitution of redundant data packets used for the correction of data.

Finally, the system can comprise data storage means such as a memory or means making it possible to carry out functions of queuing and synchronisation of the different components of the system.

Other advantages and features will become apparent from the detailed description of an embodiment which is in no way limitative and the figures in which:

FIG. 1 shows a general diagram of the use of the system according to the invention;

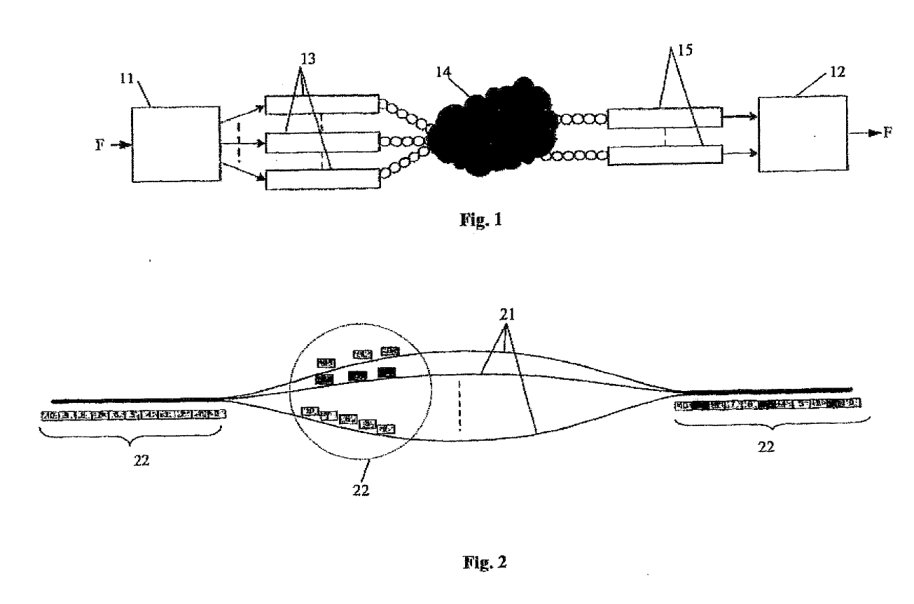

FIG. 2 is a diagram of an example of splitting and reassembly of the multimedia data stream in accordance with the method according to the invention;

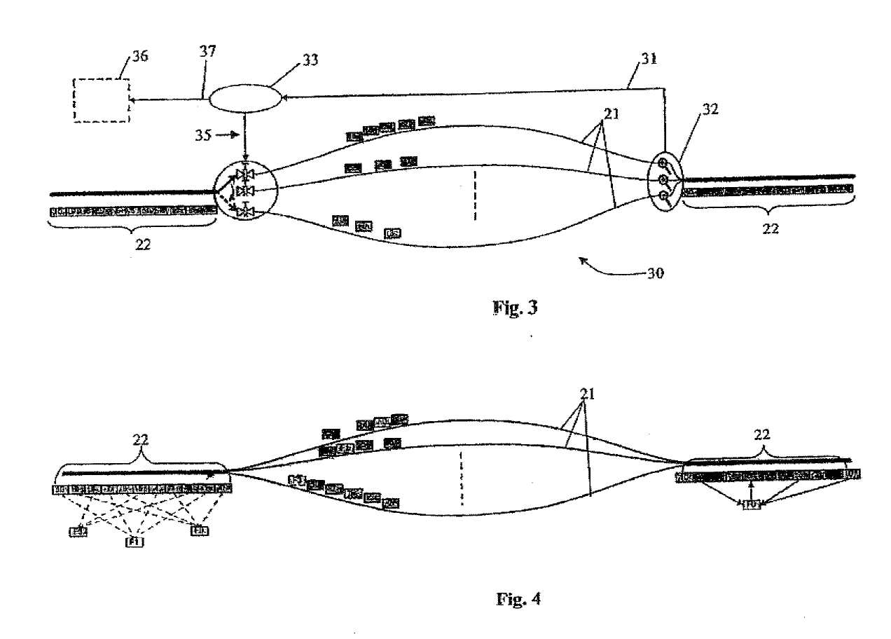

FIG. 3 is a diagram of an example of splitting and reassembly of the multimedia data stream taking into account the quality of transmission in accordance with the method according to the invention;

FIG. 4 is a diagram representing a example of Error Correction;

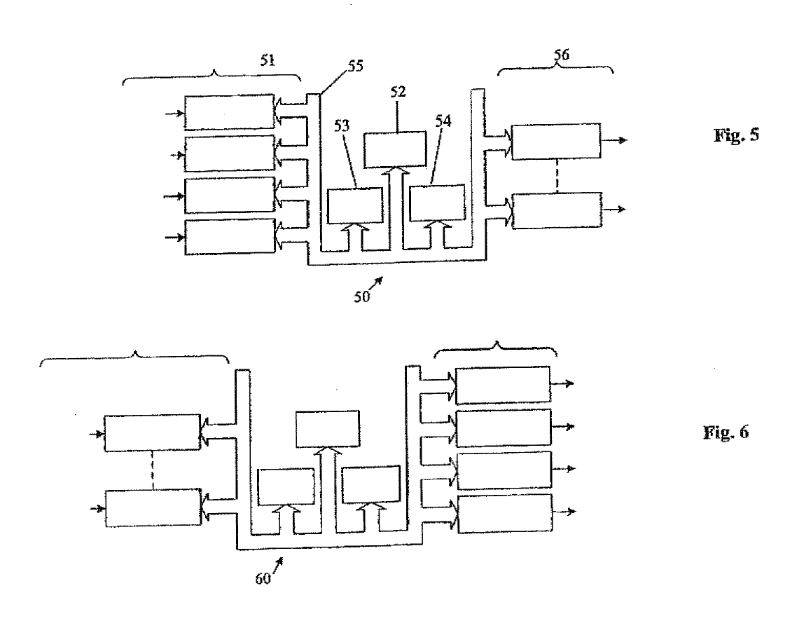

FIG. 5 shows a hardware architecture of a transmitter according to the invention;

FIG. 6 shows a hardware architecture of a receiver according to the invention;

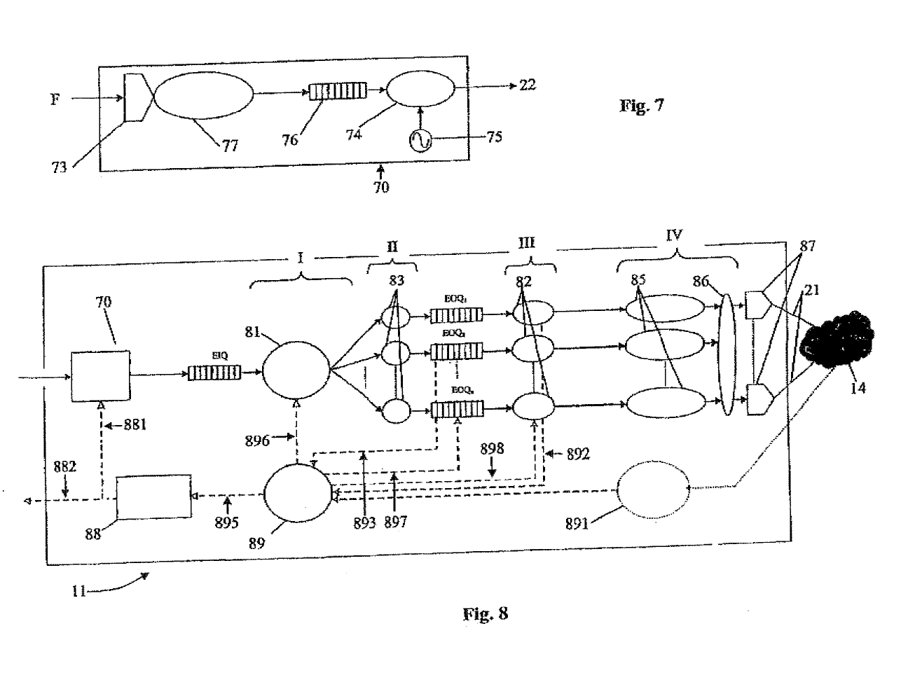

FIG. 7 is a diagram of a module of an input electrical matching module according to the invention;

FIG. 8 a diagram of a general architecture of a transmitter according to the invention;

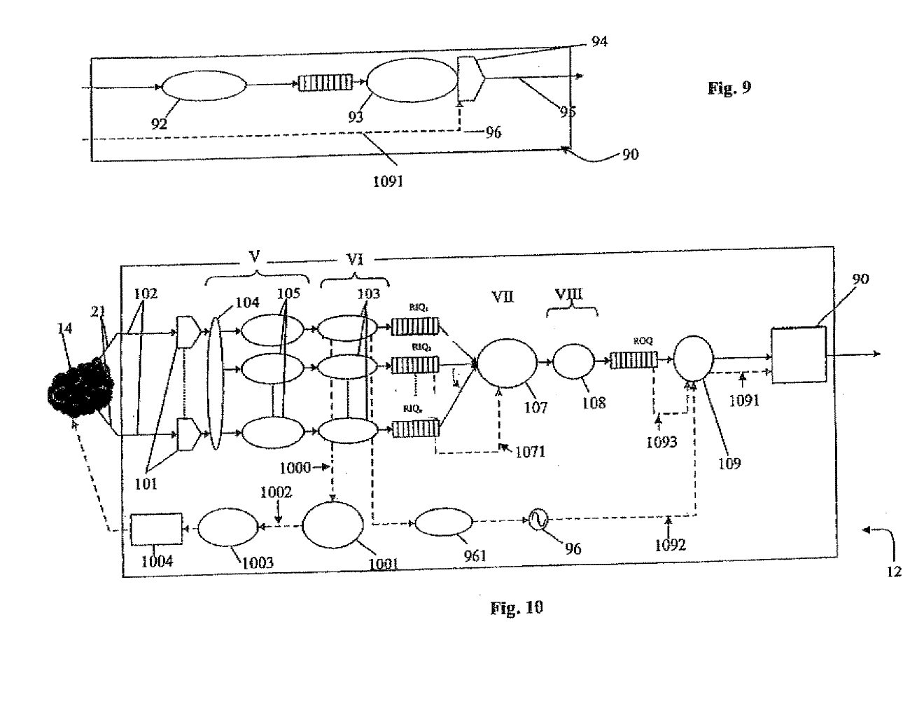

FIG. 9 is a diagram of an output electrical matching module according to the invention;

FIG. 10 is a diagram of a general architecture of a receiver according to the invention; and

The general diagram of a use of a system according to the invention is given in FIG. 1. The system is composed, among other things, of a transmitter and a receiver which are in particular respectively composed of two devices, IPSplit 11 and IPCombine 12. The multimedia data stream F to be transported is composed in this example of a digital video and audio source and can be provided according to various formats and interfaces:
MPEG2 Transport Stream on ASI,
MPEG2 Transport Stream on IP,
Non-compressed video and audio on SDI
Compressed video and audio on SDTI
. . .
   IPSplit 11 ensures the encapsulation or the re-encapsulation of these data and distributes the fragments of the multimedia data stream over several links by means of several access equipments 13 and network paths in order to have the necessary data rate and redundancy. Access to the network 14 can be carried out in many ways, the essential thing being that it is an IP network. The following can be mentioned as access means:
xDSL
Fibre
Ethernet
IP on Satellite
Wimax
. . .
   The fragments of the original multimedia data stream F are routed in the network 14 by several paths. On reception, IPCombine 12, connected with the network 14 by means of a plurality of connection equipments 15, reassembles the original multimedia data stream F from these fragments of the stream. The original multimedia data stream is delivered to the client according to different formats and interfaces:
MPEG2 Transport Stream on ASI,
MPEG2 Transport Stream on IP,
Non-compressed video and audio on SDI
Compressed video and audio on SDTI
. . .

The diagram in FIG. 2 illustrates in a general way what IPSplit 11 and IPCombine 12 provide as a function of distribution of the traffic on several paths 21. The packets 22 corresponding to the original stream F carry a sequence identifier in order to guarantee their order. If this is not the case, they are encapsulated in a packet, typically RTP, in order to add this order information. The data rate of this input stream is D. The IPSplit 11 splits the original stream of data into the different paths 21, taking account of the data rate constraints of each of the paths 21. Each path 21 conveys a data rate Di for the path i. The sum of the data rates of the paths 21 is greater than or equal to the data rate D of the original stream F. On reception, IPCombine 12 reassembles the portions of the original multimedia data stream F which are carried on each path 21 and the original multimedia data stream F is restored at the output.

To manage this, the re-sequencing mechanisms installed must take account of the effects of the network 14 with regard to:
de-sequencing of packets 22 in each path 21,
difference in latency between the different paths 21.

These two faults inserted by the IP networks 14 used are corrected by the receiver using optimized buffering and dequeuing mechanisms.

The diagram in FIG. 3 illustrates an improvement on the preceding process. In fact, the transport protocols used, described in more detail later in this document, make it possible to obtain measurements 32 of the quality of the transport channels used by the fragments of the stream. It is possible, in particular, to measure the jitter, the packet loss rate and the re-sequencing.

From these items of information, available in the receiver, a feedback loop 31 allows the transmitter to adjust the data rate allocated to each path 21 dynamically, as a function of the quality observed on each path 21. Minimum/maximum data rate constraints can be allocated by the user to each path 21 to allow him to force a control processor 33 to comply with the constraints of the subjacent network topology.

In the diagram shown in FIG. 3, this is materialized as follows:
The packets 22 are sent on each path 21 with an initial distribution fixed by the user.
A quality considered poor is measured on the path Dn. The quality is considered correct on the other paths 21.
The information returns immediately to the transmitter.
The control processor 33 applies a strategy parameterizable by the user. It can for example decide, by a control 35 to reallocate the data rate differently: to reduce that of the path n, in this instance, and to increase that of the other paths 21; he can also control the internal or external encoder 36 (if necessary) in order to vary the encoding data rate by a control 37 of the source encoder data rate.

The distribution of the fragments of the stream is modified, in our example, by increasing the data rate of the paths 1 to i to the detriment of path n. We therefore have:
for path 1. D′1≧D1, etc.
for path i: D′i≧Di,
for path n: D′n≦Dn, with D′j representing the new data rates after correction by the control 35.
   When the measured quality becomes correct again, depending on the strategy chosen in the control processor 33, the latter optionally attempts or does not attempt to progressively re-establish the values initially requested by the user (distribution between the paths and data rate of the encoder 36).

This mechanism also makes it possible to manage the redundancy of lines 21. For example, the whole of the data rate can initially be allocated to a line 21 with another line 21 without an initial data rate serving as backup. In this case, in the event of disturbance on the first line 21, a strategy for switching all of the data rate onto the second line 21 can be implemented. Another strategy can be to decide to transmit on two lines 21 and to allocate the data rate on one or other of them in order to reduce the load on the one exhibiting faults.

The following table illustrates certain cases of possible securisation (not exhaustive). It will be noted that in order to simplify this illustration, no account has been taken of the low (overhead) data rate related to the encapsulation of the multimedia data stream during splitting.

TABLE 1
Case study of securisation strategy for the transport of 8 Mb/s on different
configurations of lines

| | | IP data rate | IP data |
|---|---|---|---|
| | Useful IP line | transported - | rate transported - |
| Backup case | data rate | nominal case | degraded case |
| Lines in full backup of each other. | Line 1 (8 Mb/s) | D = 8 Mb/s | D = 0 Mb/s |
| (Degraded case without loss of | Line 2 (8 Mb/s) | D = 0 Mb/s | D = 8 Mb/s |
| performance) | | | |
| Lines with load sharing and full | Line 1 (8 Mb/s) | D/2 = 4 Mb/s | D = 0 Mb/s |
| backup of each other. | Line 2 (8 Mb/s) | D/2 = 4 Mb/s | D = 8 Mb/s |
| (Degraded case without loss of | | | |
| performance) | | | |
| Lines with load sharing and | Line 1 (4 Mb/s) | D/2 = 4 Mb/s | D = 0 Mb/s |
| partial backup of each other. | Line 2 (4 Mb/s) | D/2 = 4 Mb/s | D = 4 Mb/s |
| Degraded case with | | | |
| loss of performance (automatic | | | |
| reduction of encoding rate). | | | |

The method also makes it possible to adapt to cases of redundancies less pronounced than before. In fact, if for example a line 21 exhibits large errors or if its data rate becomes partially unavailable, the method will switch a portion of the data rate onto another line 21, until the conditions on the line 21 involved become correct again.

Finally, the examples have been presented for 2 lines 21 for the sake of simplicity, but the method makes it possible to work on an unlimited number of lines 21.

On the other hand, given that the sent multimedia data stream F is a “real time” stream, the retransmission of the lost packets cannot be envisaged. The FEC (Forward Error Correction) mechanism, added to the mechanism of splitting and reassembly, makes it possible to provide against a certain rate of loss of packets 22.

The FEC mechanism proposed conforms with the recommendation of the Pro-MPEG Forum (Code of Practice 3 or COP3).

FIG. 4 gives an overview of the general FEC mechanism. IPSplit calculates a new FEC packet F0, F1, F3 on the basis of the packets 22 of the original multimedia data stream F, redundancy information which is represented by the FEC packets. Each FEC packet is calculated on the basis of a certain number of identified original packets 22 The FEC packets are then sent on the network 14 via one or more paths 21. The stream of FEC data can follow, or not, the same partitioning strategy as the original multimedia data stream F. The data rates on the paths 21 are increased by a value Dfi which corresponds with the data rate of the FEC stream carried on the path i. This data rate depends, among other things, on the reconstruction power of the chosen FEC. The FEC data stream can, wholly or partially, be carried on at least one physical path other than those used by the multimedia data stream.

During the transport, the packet 6 is lost. On reception, IPCombine 12 detects the loss of the packet 6 and uses the FEC information in order to reconstruct it. IPCombine 12 uses the information of the packets linked with F0 (packets 0, 3 and 9) to reconstruct 6. The reconstructed packet (6r) replaces the lost packet in the output multimedia data stream.

The architecture used is a microprocessor and bus architecture, both for the transmitter and for the receiver. This architecture allows a great modularity in terms of input and of output and makes it possible to accept any kind of input and output interface adapted to this bus. Typically a bus of PCI 32 or PCI 64 (which also includes Compact PCI and PMC) will be used.

FIG. 5 shows the typical architecture 50 of the transmitter. The input cards are modular and it is possible to put one or more cards of each type, depending on the necessary interfaces 51:
a ASI acquisition interface with BNC 75Ω coaxial connections,
an Ethernet interface with a RJ45 Ethernet or Fibre Optic connector,
an encoder module or a SDI acquisition interface with SDI BNC 75Ω connections
etc.

The microprocessor 52 and the memory 53 are used for processing the various data streams. A co-processor 54 can be used for relieving the processor 52 of certain tasks.

The signals are received by the input interfaces 51, are processed by them in the case of the encoder, and are sent on the bus 55 in their digital form to the memory 53 and/or the processor 52.

The processor 52 retrieves this data and processes it, optionally with the help of the co-processor 54. The processings in question are described in detail later in this document. The processor 52 then sends the data to the output interfaces 56. These output interfaces can be composed of all S types of network interfaces, for example, of a Fast or Giga Ethernet interface with R145 or fibre optic connector technology.

FIG. 6 shows the typical architecture 60 of the receiver. The same architecture as that of the transmitter is seen again, except that the input cards in this case are generation cards.

FIG. 8 shows the detailed implementation of the transmitter. The whole of the system is described here but only those parts that are the subject of the present invention are described in detail. The other parts are of the prior art.

FIG. 7 shows an electrical input matching module 70 The multimedia stream F is received in electrical form. Several interfaces 73 are possible (ASI, SDI, Ethernet essentially). These interfaces 73 can be followed by an input protocol processing module 77. The electrical matching module 70 makes it possible to encapsulate, using an RTP encapsulation module 74, the data composing the received stream F in RTP packets 22. This is carried out for the “Transport Stream” streams, as for the SDI stream in accordance with the recommendations of:
Pro-MPEG Forum Code of Practice 3 (COP3)
RFC RTP and RFC encapsulation TS in RTP. For more information concerning RFC RTP see The Internet Society. RFC 3550 “RTP: A Transport Protocol for Real-Time Applications” and RFC 2250: “RTP Payload Format for MPEG1/MPEG2 Video”.

The module 70 can comprise a clock 74 and a FIFO 76. Optionally, the module 70 can also carry out the compression of non-compressed video and audio signals. In this case, an additional compression module generates a MPEG2-TS stream and we are therefore again in the same case as an external TS stream. Finally, in the case of an Ethernet input, the packets can be received either in the form of UDP packets containing TS packets directly, or of a stream of RTP packets containing TS packets. In this latter case, the input module will only have the task of ensuring the order of insertion of the packets into the input FIFO.

The matching module generates timestamped and sequenced RTP packets 22. These packets are placed in the input FIFO EIQ in their natural order “Sequence Number increasing and continuous”.

The packets are extracted from the input queue EIQ on the basis of the filling rate of the input queue EIQ. This rate is adjustable in order to more of less absorb the input jitter. As soon as the filling level exceeds the fixed rate, the weighted Round Robin sequencer (Weighted Round Robin or WRR) 81 will begin to extract the packets 22 from the input queue EIQ in order to process them. The objective is to distribute the stream fragments to different paths 21 whilst complying with the initial distribution constraints. This is the stage I of splitting the stream into several paths 21 These constraints are expressed as follows:
there are n paths [path₁, path₂, . . . pathₙ] on which the fractions of the initial multimedia data stream are routed,
each path i transports a portion of initial data rate referenced T(i), the fraction of the total data rate total that one wishes to be absorbed by pathᵢ. T(i)=data rate of the fragment of original multimedia data stream to be routed on pathᵢ/global data rate of this stream.
On the other hand

$${\sum }_{i = 1}^{n} T ( i ) = 1$$

such that the whole of this stream will be absorbed by the set of paths 21.

Furthermore, to allow the feedback 30 (i.e. the dynamic matching of the distribution parameters as a function of the observed quality of the paths 21), minimum and maximum values of these rates are parameterized:
Tmin(i) is the minimum fraction transportable on pathᵢ
Tmax(i) is the maximum fraction transportable on pathᵢ
with

$${\sum }_{i = 1}^{n} T max ( i ) \geq 1$$

The sequencer 81 uses T(i) as a weight for allocating the packets extracted from the input queue EIQ to each of the output queues EOQI, typically formed by FIFO's, each corresponding to a path 21. This is carried out in accordance with the operation of a Round Robin sequencer. One of the properties of the Round Robin sequencer 81 in this case is to divide the data rate in accordance with the coefficients T(i) such that if the total data rate is Dtotal, the data rate transported on the path i is Di=Dtotal.T(i).

Before being inserted into the output queue EOQi on the specified path 21, the RTP packet is re-encapsulated in a new RTP packet appropriate to each path 21, by modules 83, called “SH-Insert modules”. This is the stage II in the reference diagram. At the end of this stage, the original packets are encapsulated in a new RTP packet called RTP-SH, described in detail below.

The packets are sent on the network by means of the module 82, during a stage III, called “Dequeuing and data rate control stage”. The module extracts the packets from the output queue EOQi for the path i. A simple version of the module 82 will be simply to extract the packets according to the filling rate of the associated queue EOQi. In this case, it is the very operation of the sequencer WRR 81 which ensures the distribution of the data rate on each path.

In a more elaborate version, the module 82 can provide shaping and data rate control. In this case, the implementation is based on a conventional strategy of the “token bucket filter” type.

The module 82 extracts the RTP-SH packets from of the output queues (EOQi) in order to send them on the IP network 14 to the address and on the UDP port corresponding to each path 21. This sending of the RTP-SH packets is carried out through a UDP/IP communication layer, comprising a processing of the UDP protocol and a processing of the IP protocol by the modules 85 and 86 respectively, typically on an Ethernet support. For addressing the different paths 21, one or more IP addresses and one or more Ethernet 87 interfaces can be used.

FIG. 10 shows the details of the implementation of the stream receiver/reassembler. The streams 102 of RTP-SH packets of each path 21 are received on one or more interfaces 101, of the Ethernet type for example. Each of the paths 21 ends at a distinct pair (IP address, UDP port). This is what makes it possible to differentiate the different paths 21 on reception. The reception of the streams 102 is carried out by a module 104 for processing the IP protocol IP and a module 105 for processing the UDP protocol. This is processing stage V, involving the UDP/IP layers and the physical network interfaces. After their reception, the packets are sent to the next module for processing the RTP protocol 103, during a reading and processing stage VI of the RTP protocol.

The packets with the format RTP-SH are received on each path 21. After the conventional processing operations of the IP 104 and UDP 105 protocols, two operations are carried out on these packets:
The order of the packets is taken into account and the RTP S packets are inserted in a sequenced manner based on the “Sequence Number” into the input queue RIQi. The packets are therefore sequenced in this queue. In order to do this, the module 103 for processing the RTP protocol inserts the packet into the queue RIQi at the correct place such that the order to the SN's is complied with (strictly increasing from head to tail in the queue). The processing module 103 also eliminates doubled packets. The RIQi queue is not therefore a FIFO but a queue allowing manipulation of the position of the packets. This also makes it necessary for the reassembly algorithm (see below) to maintain each input queue RIQi at a minimum filling level to make it possible to resequence the packets in the queue directly. The value of this minimum threshold makes it possible to overcome more or less significant unsequencings. Moreover, as the latencies on all of the paths 21 are not necessarily the same, these queues make it possible to compensate for this difference and thus make it possible to put the streams 102 of the different paths back into phase to ensure optimized recomposition of the original multimedia data stream F.
Measuring the quality, over a short period and over a long period, of the stream of data received on each path. In order to do this, the module 103 of each path calculates, in particular:
   The number of packets received;
   The number of packets lost;
   The number of unsequenced packets received;
   The jitter;
   The amount of desynchronisation of the data stream;

The RTP RFC specifies how to calculate these quality indicators, in particular, the jitter. The number of packets received makes it possible to derive from this a mean data rate over a short period and over a long period. The “Timestamps” received in the RTP packets are used for synthesizing a local clock 96, which is an image of the remote clock 75. At the end of this first phase, the packets of each path 21 are present in separate queues RIQi, arranged in a sequenced manner according to the SN (decreasing from tail to head of the queue).

Stage VII comprises the reassembly of the original multimedia data stream F from the fractions of the stream 102. The reassembly process retrieves the packets from each queue RIQi, corresponding to each path (i), in order to reconstitute the original multimedia data stream. In order to optimize the extraction and to avoid resequencing the output multimedia data stream more than necessary, the next packet extracted is chosen on the basis of the smallest original SN (SNIn). The following logic is used by the sequencer 107 for reassembling the packets in an optimum manner whilst complying with two constraints:
allow resequencing in the queues RIQi before the reassembly.

In order to do this, a minimum “dequeuing” threshold is complied with for each queue (Thr(i) for the queue RIQi). This threshold corresponds to a number of packets and also corresponds to the maximum desequencing that a packet can suffer (a packet displaced by more than Thr(i) packets on a path 21 will not be resequenced by the system).
allow the absorption of the difference in latency introduced by the different transport paths. This makes it possible to put the stream 102 coming from the different paths 21 back into phase in order to allow the reassembly of the original multimedia data stream without resequencing in the output queue (ROQ).

Thus, if the maximum resequencing has not been exceeded (Thr(i)) in each path 21, the packets 22 which leave the resequencing module 107 are the packets 22 of the original multimedia data stream F, placed in ROQ according to their SNin. The logic is as follows in each (periodic) iteration

```
If all the queues Iqi's have a filling rate greater than Thr(i):
    Select from all of the Iqi's the queue IQj having the packet with
  smallest SNin at the head
    Dequeue IQj from this packet and insert it in ROQ in a sequenced
  manner
Otherwise do nothing
```

Filling rate and minimum SN data 1071 for each queue RIQi is sent to the sequencer 107.

The insertion in ROQ is done in the same way as the insertion in RIQi, i.e. whilst ensuring the correct sequence of the packet, according to SNin. The choice of the value of Thr(i) is made in such a way as to avoid an artificial latency in the RIQi queues. A value of Thr(i) proportional to the data rate of the fragment of original multimedia data stream transported on the path 21 of order i makes it possible to avoid introducing an artificial latency.

The algorithm allows the RIQi's of the paths 21 having the lowest latencies to act as “delay lines” by buffering the streams in an adaptive manner. The RIQi's must be sized to make it possible to absorb the maximum difference in latency between the paths.

Typically, each RIQi must have a size making it possible to absorb the maximum difference in latency between the paths. This size is proportional to the product of the maximum data rate of the original multimedia data stream and of the maximum difference in latency permitted between the paths 21.

The packet chosen by the preceding method is inserted into the output queue (ROQ) after the RTP-SH has been extracted from this packet, during a stage VIII of extraction of the header and of splitting and resequencing carried out by a module 108, called “SH-Extract&Seq”. The insertion in the output queue (ROQ) is accompanied by an optional resequencing according to the SN of the original multimedia data stream.

The packets 21 are extracted from the output queue by a module 109 for jitter suppression and data rate control The emptying of the packets from the queue ROQ and their transmission to the physical matching and protocol module 90 is carried out by the module 109 whose operation is activated when the filling rate of ROQ, represented by 1093 exceeds a threshold fixed during configuration.

The implementation of this module 109 is carried out on the basis of the standard methods of jitter suppression and data rate control. Among other things, it is based on the TS (“Timestamps”) of the data streams received and on the transmitted clock 96 data 1092 synthesized locally, by a module 961. It controls, by a control 1091, the output data rate of the stage of a physical matching and protocol module 90 for the output of the packets and it is this module that extracts the packets from the output queue (ROQ).

The physical matching and protocol output module 90 of the receiver is described in FIG. 9 The “payload” of the RTP packets received by this module is disencapsulated by an RTP disencapsulation module 92 and their protocol is adapted to the output medium. The raw data thus obtained are stored in a queue. The module 90 then provides, by an output protocol processing module 93, the formatting of these raw data with the output protocol specific to the chosen interface 94. In the case of Ethernet with an RTP protocol at the output 95, the reformatting stage can be eliminated. The data thus reformatted are sent to the electrical output stage 95.

It is in this stage or in the protocol reformatting stage that the output data rate is fixed. This data rate is fixed by the upstream data rate and jitter control module 109 by the command 1091.

At the receiver, quality indicators 1002 are calculated by the reception quality indicators calculation module 1001, on the basis of information 1000 transmitted by the RTP protocol processing module 103. This information 1000 includes reception per path statistics, namely information relating to jitter, packet losses, desequencing, size of reception queue, etc. The module 103 calculates, by conventional methods and for a series of time periods (short, medium and long), the following indicators:
The number of packets received and data rate,
The number of packets lost,
The number of desequenced packets received,
The jitter, and
The amount of desynchronization of the received stream

These data are optionally correlated with the values of TS and of SN which are transported in the RTP stream. The calculated indicators 1002 are transmitted by the module 1003 for sending reception statistics, followed by a network adapter 1004, to the transmitter in TCP/IP messages by means of an IP network, identical or not with the network used for transmitting the audiovisual data streams. The data are transmitted periodically, at the initiative of the receiver. The latter transmits at a regular frequency that can be set by the user but can also transmit more frequently as a function of the measured values. The network matching is the physical matching to the communication network. This is for example a matching of the Ethernet type.

The transmitter of the multimedia data stream receives the quality indicators 1002 sent in the preceding stage. A network matching is carried out previously in order to adapt to the physical medium of the IP network. The data are received in the form of TCP/IP packets, formatted with the preceding application protocol. The receiving module 891 decodes the quality indicators 1002 according to the application protocol and transmits them to the module 89 for controlling the splitting and the encoding rate.

The instantaneous data rates are calculated by the module 82. It is a simple calculation of data rate based on the reference clock 75 and on the number of packets conveyed over a given period. Conventional methods for estimating instantaneous data rate in this type of context are used.

The decisional intelligence for modifying the allocation of data rate and for modifying the encoding rate in order to adapt to the operational conditions of the network is in the module 89 for controlling the splitting and the encoding rate. This module 89 makes it possible to control the encoding rate of the matching module 88, by a control 895, the sequencer 81 by a control 896, the EOQi FIFO's by a control 897 and the modules 82 by a control 898 For these controls, it receives information 893 on the filling rate of the output FIFOs EOQI and information 892 on the instantaneous data rates of the modules 82.

The matching module 88 for controlling the encoder allows a control 881 of the input physical and protocol matching module 70 and, in particular, of the encoder if the module 70 contains one and, if necessary, a control 882 of an external encoder through an RS232, RS422 or Ethernet interface.

The principle and the format of an RTP-SH packet will now be described. A fixed structure is defined making it possible to modify the parameters of the RTP header of the packets. In fact, in order to remain in conformity with the RTP standard, a certain number of parameters of this header must be modified because of the splitting of the original stream The constant increment of the sequence numbers must be ensured. The “Payload Type” must also be modified since, strictly, the same type of data is no longer transported. Finally, the transport of information linked to the clock is necessary for a clock synthesis in the receiver and for measuring the quality of the communication links.

This header is added to the payload of the packet. The original information which is to be modified is saved in it. The standard RTP header has the following form:

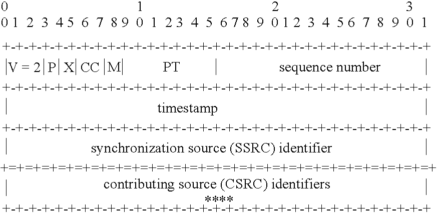

To remain compatible with RTP, in terms of continuity of SN during the splitting operation, a specific header is defined which is inserted before the “payload” of the original packet, at the start of the “payload” of the new packet. It is therefore placed between the standard RTP header and the “payload” of the original packet. This header specific, called “Splitting Header” (SH) is inserted after the CSRC if CC>0 and after the “header extension” if X=1.

Moreover, if the RTP FEC is used in accordance with Pro-MPEG COP3, the insertion of the “Splitting Header” for this type of packet is carried out in a way that is identical to that which has been described above.

It can be considered that the “Splitting Header” is a “header” specific to the “payload” in the sense of the RTP RFC. It is therefore transparent at RTP level as it is included in the RTP payload.

Moreover, the proposed “Splitting Header” is defined to make it possible to transport the transport TS (“Timestamp”) information. In fact, the definition of the TS in RTP is consistent with the concept of “presentation timestamp” defined in MPEG2 for example. It is the moment of sampling the data and not the moment of their transmission (and therefore of the timing of their transmission). It may be necessary, in order to have fine control of the transport “jitter” and of the reconstitution of the reference clock, to have to insert a transport TS, inserted at the moment of sending on the network. The proposed “Splitting Header” makes it possible to transport the preceding information and to transport the original TS, the “Transport Timestamp” being transported in the RTP header.

The RTP-SH is therefore of the following form:

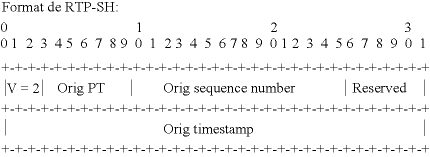

V is the version of the “Splitting Header”. The version shown is version 2.

“Orig PT” is the value of “Payload Type” in the original stream.

“Orig Sequence Number” is the value of the “sequence number” in the original stream.

The last six bits are reserved

“Orig Timestamp” is the value of the “timestamp” in the original stream.

The packets of the original stream have the following structure:

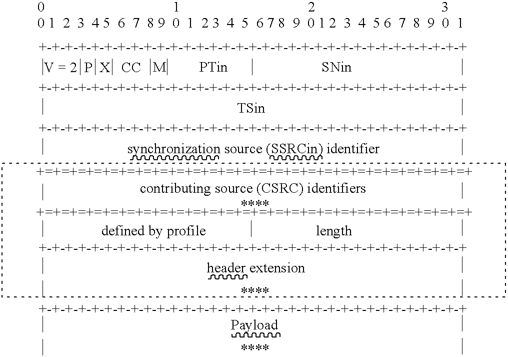

The data inside the dotted box are optional, depending on the values of X and CC. The content of the RTP header is modified during the passage through the transmitter at SH level and in the receiver. The modifications are carried out as follows:
the transmitter substitutes the PT (Payload Type), SN (Sequential Number) and TS (TimeStamp) values of the original packet with values appropriate to the split stream. PT is a characteristic value of a split stream and SN is recalculated by the transmitter in order to comply with the RTP recommendation, namely that the value SN increases by 1 in each packet.
the other values remain unchanged in the fixed RTP Header.
if necessary, the values contained in the list of CSRC are unchanged.
if necessary, the content of the “Header Extension” remains unchanged.
if necessary, the values of the FEC “Header” and of its possible extension remain unchanged.
the transmitter inserts the “Splitting Header” in the header of the “payload” of the original packet. The original values of “PTin” and “SNin” are copied in the “Splitting Header”.

At the output of the transmitter, the packets of the split streams have the following form:

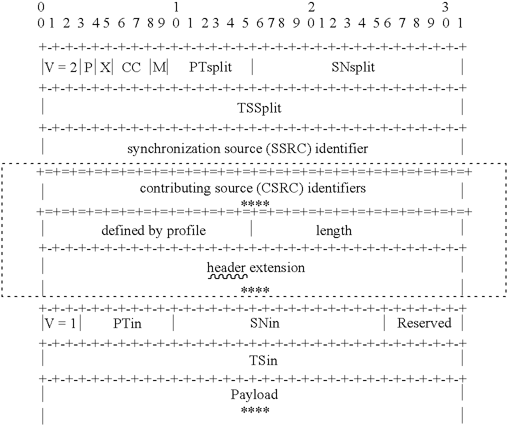

The “payload” of this new RTP packet is constituted by the “Splitting Header” and the “payload” of the original packet. In the above diagram, it starts below the area enclosed in dotted line.

“PTSplit”, “SNSplit” and “TSSplit” are values inserted by the transmitter to correspond with the RTP requirements. These values are used for characterizing the quality of the link corresponding to the path that these packets will use. “PTin”, “SNin” and “TSin” are the copies of the values of the “header” of the original RTP stream, they are used for reconstructing the stream at destination.

The invention is not limited to the application to the example described above and is applicable to the transmission of any multimedia data stream.

1. Method for transmitting a multimedia data stream (F) from at least one transmitter to at least one receiver through at least one link comprising at least one communication network (14) of the IP type, said method comprising the following stages:
packeting, on transmission, of at least a portion of the data of the multimedia data stream (F) in accordance with at least one predefined format, said packeting comprising the following stages:
1. splitting of said stream (F), and
2. encapsulation of said split stream in at least one data packet conforming with said predefined format, said data packet moreover comprising data relating to said splitting;
transmission of the packets (22) thus formed from the transmitter to the receiver, at least one part of said link between the transmitter and the receiver being constituted by a plurality of predefined separate physical paths (21).

2. Method according to claim 1, characterized in that it comprises a feedback (30), from the receiver to the transmitter, making it possible to regulate the transmission of the packets (22) of multimedia data, said feedback (30) being carried out by a sending from the receiver to the transmitter of at least one indicator (1002) relating to the transmission of the packets (22) on at least one physical path (21).

3. Method according to claim 1, characterized in that the splitting (i) of the stream is carried out at a data rate adjusted according to at least one parameter, called the weight, determine as a function of at least one item of data chosen from the following list: initialisation parameter, transmission quality indicator (1002), data rate relative to another operation.

4. Method according to claim 1, characterized in that it comprises, on reception, a correction of at Least one error in the transmission of packets (22) of received multimedia data due to redundant data (FO, F1, F3).

5. Method according to claim 1, characterized in that it comprises moreover a distribution (I) of the data stream on a plurality of physical transmission paths (21), according to information relating to at least one transmission path (21).

6. Method according to claim 1, characterized in that the splitting of packets (22) of data is adjusted dynamically, essentially as a function of at least one fixed or variable transmission data rate on at least one path (21).

7. Method according to claim 1, characterized in that the splitting of packets (22) of data is adjusted dynamically essentially as a function of at least one transmission jitter value on at least one path (21).

8. Method according to claim 1, characterized in that the stage (II) of packeting comprises at least one encapsulation of the data in a packet conforming with the Real Time Protocol (RTP) on at least one path (21).

9. Method according to claim 1, characterized in that it comprises moreover a transmission (IV) of data packets from the transmitter to the receiver, through a plurality of physical paths (21), each of these physical paths (21) being addressed by the transmitter using one or more IP (Internet Protocol) addresses.

10. Method according to claim 1, characterized in that it comprises moreover a reception (V), by the receiver, of data packets on a plurality of physical paths (21), each of these physical paths (21) emerging on a (IP address, UDP port) pair.

11. Method according to claim 1, characterized in that it comprises moreover an extraction (VIII) of multimedia data from at least one received packet.

12. Method according to claim 1, characterized in that it comprises moreover a reassembly (VII) of a plurality of packets received on a plurality of physical link paths (21) between the transmission network (14) and the receiver, said packets being selected on said plurality of paths (21) according to the items of information that they contain.

13. Method according to claim 1, characterized in that a reception of a new packet is followed by a sequencing of this packet in a queue (RIQI) according to information relating to the new received packet and/or to at least one packet received previously.

14. Method according to claim 1, characterized in that it comprises moreover a measurement of at least one transmission quality indicator (1002) on at least one physical link path (21) as a function of information relating either to the transmission, or to the multimedia data transmitted on said path (21), or to both of these.

15. Method according to claim 2, characterized in that the feedback (30) results in an adjustment of a data transmission rate art at least one path (21) as a function of at least one indicator (1002) relating to the transmission.

16. Method according to claim 2, characterized in that the feedback is carried out on at least one physical path.

17. Method according to claim 1, characterized in that it comprises a matching allowing a formatting of the data of the multimedia data stream (F) to be transmitted according to at least one predefined format.

18. Method according to claim 17, characterized in that the formatting of the data is carried out at a data rate adjusted as a function of at least one parameter chosen from the following list: initialisation parameter, a transmission quality indicator (1002), any data rate.

19. Method according to claim 1, characterized in that the transmission comprises a sending, from the transmitter to the receiver, of redundant packets (P0, F1, F3) of the multimedia stream (F) to be transmitted.

20. System for transmitting a multimedia data stream from at least one transmitter to at least one receiver through at least one link comprising at least one communication network (14) utilizing the IP protocol, comprising:
means (83) of putting into packets (22), on transmission, at least a portion of the data of the data stream (F) conforming to a predefined format, said packeting means comprising:
1. means of splitting said stream (F), and
2. means of encapsulating said split stream in at least one data packet conforming to said predefined format, said data packet moreover comprising data relating to said splitting;
means of transmission of the packets thus formed from the transmitter to the receiver through said communication network (14); and
link means from said transmitter so said receiver, at least one part of said link being constituted by a plurality of predefined separate physical paths (21).
